(19) United States
(12) Patent Application Publication
(10) Pub. No.: US 2024/0391816 A1
(43) Pub. Date: Nov. 28, 2024

(54) GLASS MANUFACTURING APPARATUS WITH LEAK MITIGATION FEATURES

(71) Applicant: CORNING INCORPORATED, Corning, NY (US)

(72) Inventors: Charles Collins Bentley, III, Danville, KY (US); Ahdi El-Kahlout, Horseheads, NY (US); Jason Arthur Howles, Corning, NY (US); Chien Yu Hsu, Taichung (TW); John Thomas Pine, III, Horseheads, NY (US); Jeremy Walter Turner, Beaver Dams, NY (US)

(21) Appl. No.: 18/555,798

(22) PCT Filed: Apr. 12, 2022
(86) PCT No.: PCT/US2022/024365

§ 371 Date: Oct. 17, 2023

Related U.S. Application Data
(60) Provisional application No. 63/177,524, filed on Apr. 21, 2021.

(51) Int. Cl. C03B 7/088; C03B 5/167; C03B 7/094; C03B 17/06

(52) U.S. Cl. CPC C03B 7/088; C03B 5/167; C03B 7/094; C03B 17/064

(57) ABSTRACT

A glass manufacturing apparatus includes an exit conduit positioned to deliver molten glass from a delivery vessel to an inlet conduit of a forming apparatus. The apparatus also includes a leak blocking component that circumferentially surrounds a portion of the exit conduit and is configured to inhibit flow of molten glass towards an outer surface of the glass manufacturing apparatus.

### CROSS REFERENCE TO RELATED APPLICATIONS

This application claims the benefit of priority under 35 U.S.C. § 119 of U.S. Provisional Application Ser. No. 63/177,524, filed on Apr. 21, 2021, the content of which is relied upon and incorporated herein by reference in its entirety.

### FIELD

The present disclosure relates generally to a glass manufacturing apparatus and more particularly to a glass manufacturing apparatus with leak mitigation features.

### BACKGROUND

Glass articles, such as thin glass sheets, are used in display applications, such as televisions, tablets, and smartphones. In the manufacture of such articles, molten glass is often flowed through one or more conduits. During a manufacturing campaign, leaks along or between such conduits can cause undesirable results, such as glass articles with reduced quality, process downtime, and/or repair or replacement of processing components. Accordingly, it is desirable to minimize these effects.

### SUMMARY

Embodiments disclosed herein include a glass manufacturing apparatus. The glass manufacturing apparatus includes an exit conduit positioned to deliver molten glass from a delivery vessel to an inlet conduit of a forming apparatus. The glass manufacturing apparatus also includes a leak blocking component that circumferentially surrounds sa portion of the exit conduit and is configured to inhibit flow of molten glass towards an outer surface of the glass manufacturing apparatus.

Embodiments disclosed herein also include a glass manufacturing apparatus. The glass manufacturing apparatus includes an exit conduit positioned to deliver molten glass from a delivery vessel to an inlet conduit of a forming apparatus. And end of the exit conduit extends into an open end of the inlet conduit such that an annular gap is disposed between the open end of the inlet conduit and the end of the exit conduit. A leak blocking component circumferentially surrounds a portion of the exit conduit and is positioned over the open end of the inlet conduit. The leak blocking component is configured to inhibit flow of molten glass toward an outer surface of the glass manufacturing apparatus.

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding, and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a schematic view of an example fusion down draw glass making apparatus and process;

FIG. 2 is a schematic cross-sectional view of a portion of a glass making apparatus;

FIG. 3 is a perspective view of a leak blocking component in accordance with embodiments disclosed herein;

FIG. 4A is a top perspective view of a leak blocking component in a joined position accordance with embodiments disclosed herein;

FIG. 4B is a top perspective view of a leak blocking component in a separated position in accordance with embodiments disclosed herein;

FIG. 5 is a side perspective view of a leak blocking component and a thermally insulating component in accordance with embodiments disclosed herein; and

FIG. 6. is an exploded perspective view of a portion of the leak blocking component of FIG. 5; and

FIG. 7 is a schematic cross-sectional view of a portion of a glass making apparatus including a leak blocking component and a thermally insulating component.

### DETAILED DESCRIPTION

Reference will now be made in detail to the present preferred embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

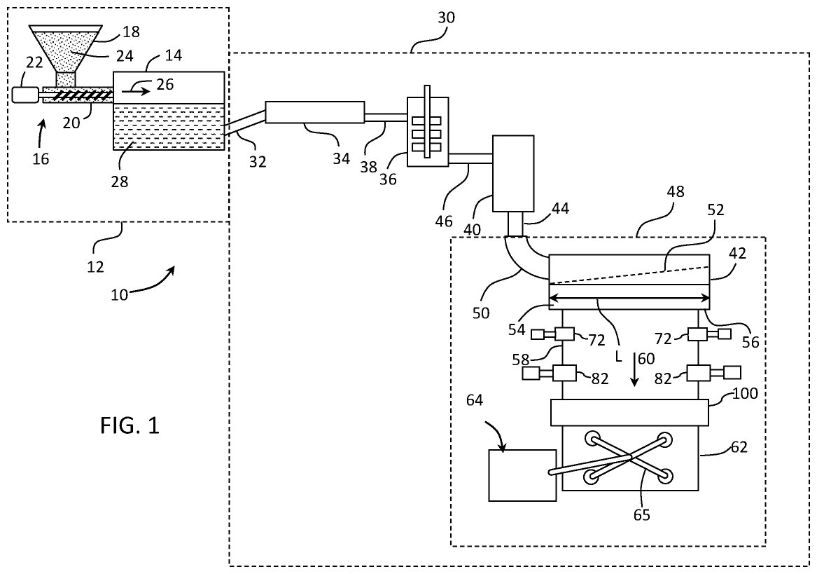

Shown in FIG. 1 is an exemplary glass manufacturing apparatus 10. In some examples, the glass manufacturing apparatus 10 can comprise a glass melting furnace 12 that can include a melting vessel 14. In addition to melting vessel 14, glass melting furnace 12 can optionally include one or more additional components such as heating elements (e.g., combustion burners or electrodes) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks. Specific embodiments of glass melting vessel 14 will be described in more detail below.

In some examples, the glass melting furnace may be incorporated as a component of a glass manufacturing apparatus to fabricate a glass sheet, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein. By way of example, FIG. 1 schematically illustrates glass melting furnace 12 as a component of a fusion down-draw glass manufacturing apparatus 10 for fusion drawing a glass ribbon for subsequent processing into individual glass sheets.

The glass manufacturing apparatus 10 (e.g., fusion down-draw apparatus 10) can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw materials 24 that can be fed into melting vessel 14 of glass melting furnace 12, as indicated by arrow 26. Raw materials 24 typically comprise one or more glass forming metal oxides and one or more modifying agents. In some examples, raw material delivery device 20 can be powered by motor 22 such that raw material delivery device 20 delivers a predetermined amount of raw materials 24 from the storage bin 18 to melting vessel 14. In further examples, motor 22 can power raw material delivery device 20 to introduce raw materials 24 at a controlled rate based on a level of molten glass sensed downstream from melting vessel 14. Raw materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 70 to about 90% by weight platinum and about 10% to about 30% by weight rhodium. However, other suitable metals can include molybdenum, palladium, rhenium, tantalum, titanium, tungsten and alloys thereof.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. It should be understood, however, that other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process, or cooled to a temperature lower than the temperature of the molten glass in the melting vessel before entering the fining vessel.

Bubbles may be removed from molten glass 28 within fining vessel 34 by various techniques. For example, raw materials 24 may include multivalent compounds (i.e. fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the molten glass and the fining agent. Oxygen bubbles produced by the temperature-induced chemical reduction of the fining agent(s) rise through the molten glass within the fining vessel, wherein gases in the molten glass produced in the melting furnace can diffuse or coalesce into the oxygen bubbles produced by the fining agent. The enlarged gas bubbles can then rise to a free surface of the molten glass in the fining vessel and thereafter be vented out of the fining vessel. The oxygen bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. It should be noted that while mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to forming body 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced forming body 42 and inlet conduit 50. Exit conduit 44 can be positioned to deliver molten glass 28 from delivery vessel 40 to inlet conduit 50 of forming apparatus 48. For example, exit conduit 44 may be nested within and spaced apart from an inner surface of inlet conduit 50, thereby providing a free surface of molten glass positioned between the outer surface of exit conduit 44 and the inner surface of inlet conduit 50. Forming body 42 in a fusion down draw glass making apparatus can comprise a trough 52 positioned in an upper surface of the forming body and converging forming surfaces 54 that converge in a draw direction along a bottom edge 56 of the forming body. Molten glass delivered to the forming body trough via delivery vessel 40, exit conduit 44 and inlet conduit 50 overflows side walls of the trough and descends along the converging forming surfaces 54 as separate flows of molten glass. The separate flows of molten glass join below and along bottom edge 56 to produce a single ribbon of glass 58 that is drawn in a draw or flow direction 60 from bottom edge 56 by applying tension to the glass ribbon, such as by gravity, edge rolls 72 and pulling rolls 82, to control the dimensions of the glass ribbon as the glass cools and a viscosity of the glass increases. Accordingly, glass ribbon 58 goes through a visco-elastic transition and acquires mechanical properties that give the glass ribbon 58 stable dimensional characteristics. Glass ribbon 58 may, in some embodiments, be separated into individual glass sheets 62 by a glass separation apparatus 100 in an elastic region of the glass ribbon. A robot 64 may then transfer the individual glass sheets 62 to a conveyor system using gripping tool 65, whereupon the individual glass sheets may be further processed.

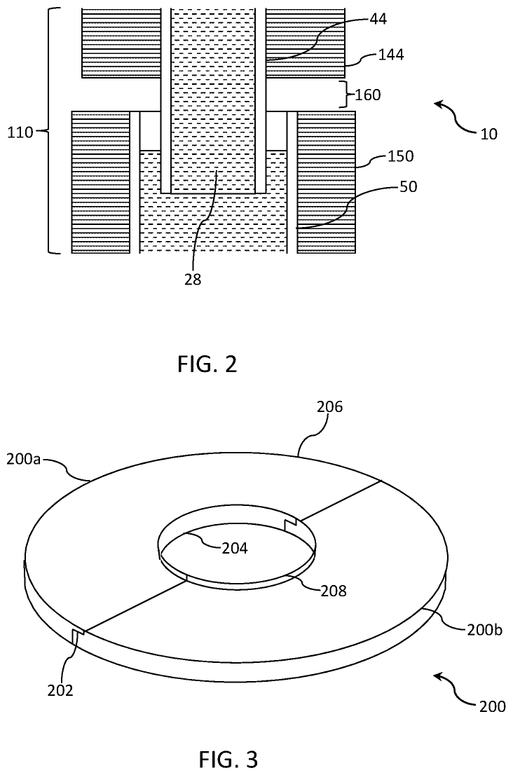

FIG. 2 shows a schematic cross-sectional view of a portion of glass making apparatus 10. Specifically, FIG. 2 shows exit conduit 44 positioned to deliver molten glass 28 from delivery vessel (not shown in FIG. 2) to inlet conduit 50 of a forming apparatus (not shown in FIG. 2). As shown in FIG. 2, a portion of exit conduit 44 extends into and is circumferentially surrounded by a portion of inlet conduit 50. Exit conduit 44 and inlet conduit 50 are, respectively, circumferentially surrounded by first and second heat transfer elements (e.g., heating elements) 144 and 150. Gap 160 extends between first and second heat transfer elements 144 and 150. Under certain circumstances, molten glass 28 may undesirably flow towards outer surface 110 of the glass manufacturing apparatus 10 (e.g., leak from exit conduit 44 through gap 160). In addition, molten glass 28 may undesirably flow from outer surface of exit conduit 44 into inlet conduit 50 (e.g., drip from an outer surface of heating element 144 into inlet conduit 50).

FIG. 3 shows a perspective view of a leak blocking component 200 in accordance with embodiments disclosed herein. Leak blocking component 200 has a generally cylindrical shape and includes a first segment 200a and a second segment 200b that are joined together via joint region 202. Leak blocking component 200 also includes an inner circumferential surface 204 and an outer circumferential surface 206. Inner circumferential surface 204 extends in a greater axial distance than outer circumferential surface 206 such that lip 208 extends above the remainder of leak blocking component 200. And while leak blocking component 200 is shown in FIG. 3 as having a generally cylindrical shape (i.e., generally circular cross-section), embodiments disclosed herein include those in which leak blocking component 200 has other shapes, such as those with polygonal cross-sections (e.g., triangular, rectangular, pentagonal, hexagonal, octagonal, etc.).

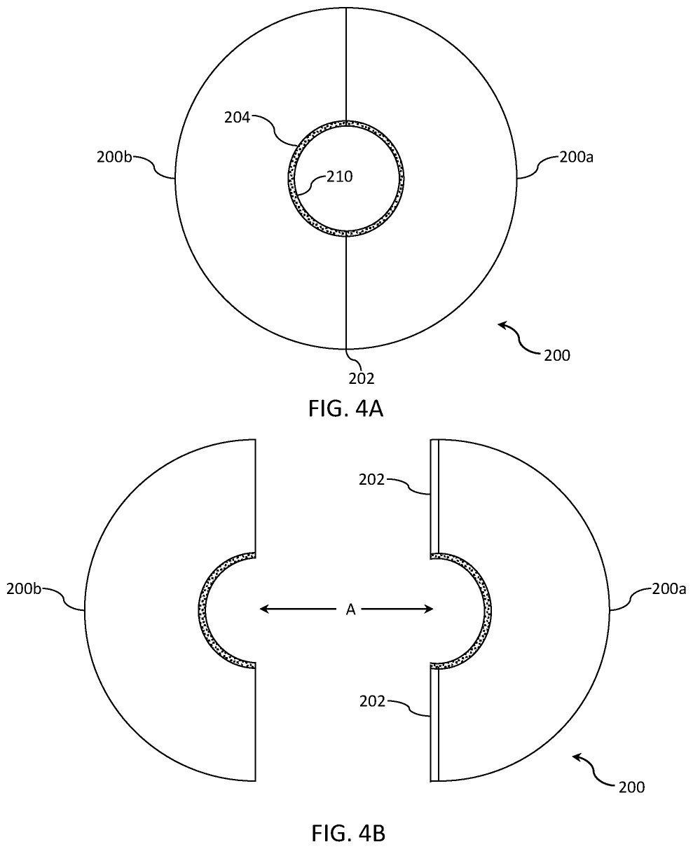

FIGS. 4A and 4B show, respectively, top perspective views of a leak blocking component 200 in joined position and separated positions. In the joined position, shown in FIG. 4A, first segment 200a and second segment 200b of leak blocking component 200 are joined together, for example by a lap joint, along joint region 202. Joint region 202 can include a clamping or tightening mechanism (not shown) whereby varying degrees of tightness can be established between first segment 200a and second segment 200b. As further shown in FIG. 4A, inner circumferential surface 204 of leak blocking component 200 is coated with a refractory coating 210. First segment 200a and second segment 200b of leak blocking component 200 can be separated as illustrated by double arrow ‘A’ in FIG. 4B. Accordingly, first segment 200a and second segment 200b are movable between a separated position and a joined position.

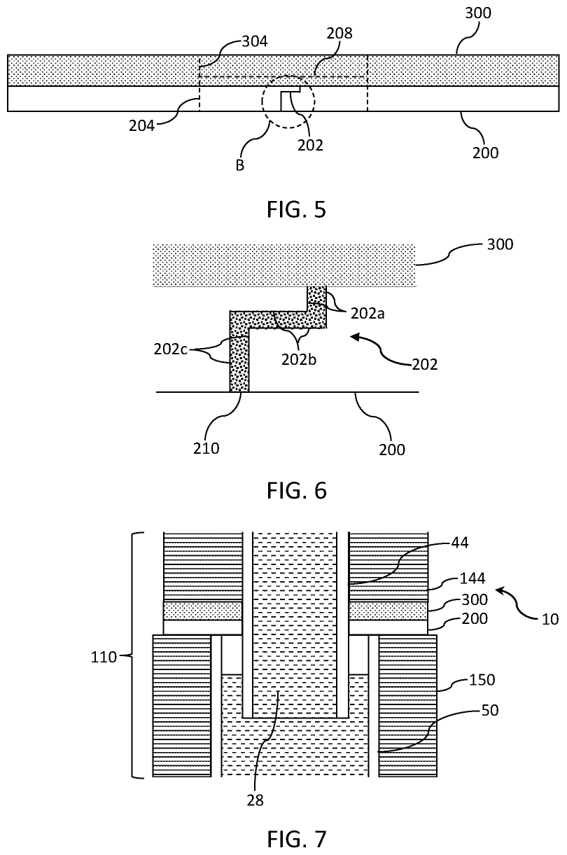

FIG. 5 shows a side perspective view of a leak blocking component 200 and a thermally insulating component 300 in accordance with embodiments disclosed herein. As with leak blocking component 200, thermally insulating component 300 has a generally cylindrical shape and an inner circumferential surface 304. As shown in FIG. 5, thermally insulating component 300 extends in a generally parallel direction with leak blocking component 200 and physically contacts leak blocking component 200. In addition, a portion of inner circumferential surface 304 of thermally insulating component 300 contacts lip 208 of leak blocking component 200. While FIG. 5 shows inner circumferential surfaces 204 and 304 extending around a similar diameter, embodiments disclosed herein include those in which inner circumferential surface 304 extends around a larger or smaller diameter than inner circumferential surface 204.

FIG. 6. shows an exploded perspective view of a portion of the leak blocking component 200 shown in area ‘B’ of FIG. 5. Specifically, FIG. 6 shows an exploded view of joint region 202 of leak blocking component 200. As shown in FIG. 6, joint region 202 includes first vertical faces 202a, horizontal faces 202b, and second vertical faces 202c. As further shown in FIG. 6, each of first vertical faces 202a, horizontal faces 202b, and second vertical faces 202c are coated with refractory coating 210.

FIG. 7 shows a schematic cross-sectional view of a portion of glass making apparatus 10 that is similar to the portion of glass making apparatus 10 shown in FIG. 2 except glass making apparatus 10 includes leak blocking component 200 and thermally insulating component 300. Specifically, leak blocking component 200 circumferentially surrounds a portion of exit conduit 44. Leak blocking component 200 also physically contacts inlet conduit 50 and has a larger diameter than inlet conduit 50. Thermally insulating component 300 also circumferentially surrounds a portion of exit conduit 44 and may physically contact leak blocking component 200. Leak blocking component 200 and thermally insulating component 300 each extend axially along and effectively fill gap 160 shown in FIG. 2. Inner circumferential surface 204 of leak blocking component 200, including lip 208, may physically contact a portion of exit conduit 44 or a small annular gap may extend between inner circumferential surface 204 of leak blocking component 200 and exit conduit 44. Inner circumferential surface 304 of thermally insulating component 300 may also physically contact a portion of exit conduit 44. In addition, at least an outer circumferential region of leak blocking component 200 may rest on second heat transfer element 150 and thermally insulating component 300 may physically contact first heat transfer element 144. Leak blocking component 200 may also be supported by being connected to or hung from heating element 144 (e.g., via support brackets, etc.).

In certain exemplary embodiments, leak blocking component 200 can be positioned on exit conduit 44 by positioning first segment 200a and second segment 200b of leak blocking component 200 on opposing sides of exit conduit 44 and then clamping or tightening first segment 200a and second segment 200b into a joined position wherein leak blocking component 200 circumferentially surrounds exit conduit 44. The degree of tightness with which first segment 200a is joined with second segment 200b can be adjusted so as to account for expansion or contraction (e.g., thermal expansion or contraction) of exit conduit 44 and/or leak blocking component 200.

In certain exemplary embodiments, exit conduit 44 and leak blocking component 200 each comprise platinum or an alloy thereof. In certain exemplary embodiments, leak blocking component 200 comprises a refractory material clad with platinum or an alloy thereof. In certain exemplary embodiments, the refractory material and the platinum or alloy of the leak blocking component 200 can be welded together. In certain exemplary embodiments, the refractory material of the leak blocking component 200 can comprise alumina or an aluminosilicate material, such as a high temperature pressed alumina-containing refractory material, such as Alundum (e.g., AN485, AN498, AH199) available from St. Gobain, alumina bubble high temperature refractory, such as NA-33 available from Harbison Walker or FL-33 available from Rath, aluminosilicate material, such as crystalline HF339 available from Emhart Glass, TAMAX or GEM available from Harbison Walker, or Resistal S60 or Resistal S70 available from RHI. The refractory material of the leak blocking component 200 may also comprise ceramic oxides such as zirconia, zircon, and magnesia. In certain exemplary embodiments, the platinum or platinum alloy clad can have a thickness ranging from about 10 to about 100 mils, such as from about 40 to about 80 mils.

In certain exemplary embodiments, lip 208 can have a thickness in the radial direction ranging from about 40 to about 80 mils. In certain exemplary embodiments, lip 208 can extend at least 0.1 inch, such as from about 0.1 inch to about 1 inch, including from about 0.25 inch to about 0.75 inch above the remainder of leak blocking component 200.

In certain exemplary embodiments, thermally insulating component 300 can comprise a refractory insulative material such as a board material comprising alumina, silica, and/or mullite fibers, such as a board material comprising Fiberfrax and/or Fibermax fibers, such as vacuum-formed ceramic or glass fiber board, such as Duraboard available from Unifrax or KVS161 board available from Rath.

In certain exemplary embodiments, refractory coating 210 may comprise an alumina ceramic coating, such as Rokide available from St. Gobain.

In operation, leak blocking component 200 can inhibit flow of molten glass 28 towards an outer surface of the glass manufacturing apparatus 10. For example, leak blocking component 200 can cause molten glass 28 to pile above its surface and/or above surface of thermally insulating component 300 while effectively inhibiting any flow of molten glass 28 out of gap 160.

Embodiments disclosed herein can minimize leaks along or between conduits of a glass manufacturing apparatus, resulting in glass articles with improved quality as well as a reduction in process downtime and/or reduced need to replace or repair processing components.

While the above embodiments have been described with reference to a fusion down draw process, it is to be understood that such embodiments are also applicable to other glass forming processes, such as float processes, slot draw processes, up-draw processes, tube drawing processes, and press-rolling processes.

It will be apparent to those skilled in the art that various modifications and variations can be made to embodiment of the present disclosure without departing from the spirit and scope of the disclosure. Thus, it is intended that the present disclosure cover such modifications and variations provided they come within the scope of the appended claims and their equivalents.

What is claimed is:

1. A glass manufacturing apparatus comprising:
an exit conduit positioned to deliver molten glass from a delivery vessel to an inlet conduit of a forming apparatus, wherein:
a leak blocking component circumferentially surrounds a portion of the exit conduit and is configured to inhibit flow of molten glass towards an outer surface of the glass manufacturing apparatus.

2. The glass manufacturing apparatus of claim 1, wherein a portion of the exit conduit extends into and is circumferentially surrounded by a portion of the inlet conduit.

3. The glass manufacturing apparatus of claim 2, wherein the leak blocking component contacts the inlet conduit.

4. The glass manufacturing apparatus of claim 1, wherein the apparatus further comprises a thermally insulating component that circumferentially surrounds a portion of the exit conduit and contacts the leak blocking component.

5. The glass manufacturing apparatus of claim 1, wherein the leak blocking component comprises a first segment and a second segment that are movable between a separated position and a joined position.

6. The glass manufacturing apparatus of claim 5, wherein the leak blocking component comprises a joint region wherein a portion of the first segment overlaps a portion of the second segment.

7. The glass manufacturing apparatus of claim 1, wherein the exit conduit and the leak blocking component each comprise platinum or an alloy thereof.

8. The glass manufacturing apparatus of claim 7, wherein the leak blocking component comprises a refractory material clad with platinum or an alloy thereof.

9. The glass manufacturing apparatus of claim 8, wherein an inner circumferential surface of the leak blocking component is coated with a refractory coating.

10. The glass manufacturing apparatus of claim 6, wherein the joint region comprises a refractory coating.

11. A glass manufacturing apparatus comprising:
an exit conduit positioned to deliver molten glass from a delivery vessel to an inlet conduit of a forming apparatus, an end of the exit conduit extending into an open end of the inlet conduit such that an annular gap is disposed between the open end of the inlet conduit and the end of the exit conduit;
a leak blocking component circumferentially surrounding a portion of the exit conduit and positioned over the open end of the inlet conduit, the leak blocking component configured to inhibit flow of molten glass toward an outer surface of the glass manufacturing apparatus.

12. The glass manufacturing apparatus of claim 11, wherein the leak blocking component comprises a first segment and a second segment that are movable between a separated position and a joined position.

13. The glass manufacturing apparatus of claim 12, wherein the leak blocking component comprises a joint region wherein a portion of the first segment overlaps a portion of the second segment.

14. The glass manufacturing apparatus of claim 13, wherein the joint region comprises a refractory coating.

15. The glass manufacturing apparatus of claim 11, wherein the apparatus further comprises a thermally insulating component that circumferentially surrounds a portion of the exit conduit and contacts the leak blocking component.

16. The glass manufacturing apparatus of claim 11, wherein a first heat transfer element circumferentially surrounds at least a portion of the exit conduit and a second heat transfer element circumferentially surrounds at least a portion of the inlet conduit and the leak blocking component is disposed in a gap between the first heat transfer element and the second heat transfer element.
